(19) United States
(12) Patent Application Publication
(10) Pub. No.: US 2025/0119721 A1
(43) Pub. Date: Apr. 10, 2025

(54) INFRASTRUCTURE SYSTEM EMERGENCY MANAGEMENT

(71) Applicant: RAPIDSOS, INC., New York, NY (US)

(72) Inventor: Conor Fucci, New York, NY (US)

(21) Appl. No.: 18/902,592

(22) Filed: Sep. 30, 2024

Related U.S. Application Data
(60) Provisional application No. 63/543,453, filed on Oct. 10, 2023.

(51) Int. Cl. H04W 4/90; H04L 67/02; H04L 67/10; H04W 4/14

(52) U.S. Cl. CPC H04W 4/90; H04L 67/02; H04L 67/10; H04W 4/14

(57) ABSTRACT

An emergency management system includes at least one processor operative to: provide a first data interface from a cloud server to an infrastructure operations center, operative to receive infrastructure emergency data from the infrastructure operations center by the cloud server. A second data interface from the cloud server to an information database is operative to send a query to the information database including the infrastructure emergency data, and to receive infrastructure emergency handling protocol information by the cloud server in response to the query message. A third data interface to an emergency communications center network entity is operative to send an infrastructure emergency message to an emergency communication center to initiate dispatch of emergency responders to a location of the infrastructure emergency. The processor is also operative to send a message with infrastructure emergency information received via the second data interface to a plurality of emergency responder devices.

### CROSS-REFERENCE TO RELATED APPLICATIONS

The present application claims priority to U.S. Provisional Patent Application No. 63/543,453, filed Oct. 10, 2023, entitled “INFRASTRUCTURE SYSTEM EMERGENCY MANAGEMENT” which is hereby incorporated by reference herein in its entirety, and which is assigned to the same assignee as the present application.

### FIELD OF THE DISCLOSURE

The present disclosure relates generally to public and private infrastructure systems, and more particularly, apparatuses, systems and methods for responding to emergencies related to public and private infrastructure systems.

### BACKGROUND

Infrastructure systems encounter problems and emergencies on a daily basis. Infrastructure systems include both public and private infrastructure systems. Public infrastructure refers to governmentally developed, owned and operated infrastructure facilities, systems, and structures that are open to the general public for use. Whereas private infrastructure refers to any infrastructure not owned by or dedicated to a governmental or public entity or authority. In some situations, infrastructure systems may be a combination of public and private infrastructure. That is, some portions of infrastructure systems may be public whereas portions may be privately owned.

Examples of infrastructure systems include, but are not limited to, transport infrastructure such as roads, rail, cable, and shipping ports; aviation infrastructure such as air traffic control technology; rail transport such as trackage, signals, electrification of rails; road transport such as roads, bridges, tunnels; critical infrastructure such as assets required to sustain human life; energy infrastructure such as transmission and storage of fossil fuels and renewable sources; electrical grid such as transmission and distribution stations, power lines, power plants, etc.; hazardous waste such as disposal and handling; information and communication infrastructure such as systems of information storage and distribution; solid waste such as generation, collection, management of trash, garbage and recycling; water infrastructure for the distribution and maintenance of water supply; wastewater infrastructure for disposal and treatment of wastewater, etc.

Many of these infrastructure systems may encounter emergencies that involve not only the specific infrastructure system, but multiple facets of infrastructure systems that may need to work together to resolve emergencies. In one example, transport infrastructure such as railways may be used to transport hazardous material. If a train derailment occurs for a train carrying hazardous materials, the emergency may involve hazardous material containment and management, in addition to railway issues, and the event could present dangers of toxicity to the emergency responders as well as the surrounding community where the derailment occurred. Time is of the essence in responding to such dangers. Many other dangerous situations occur for downed power lines, pipeline spills, gas leaks and other emergencies related to infrastructure systems. Each possible situation requires handling using specific knowledge related to the situation however, unfortunately, the required information is not available to emergency responders in a timely manner.

### BRIEF DESCRIPTION OF THE DRAWINGS

FIG. 1 is a diagram illustrating an emergency data manager in communication with various infrastructure systems and sensors, various emergency networks, mobile devices, and emergency responder devices.

FIG. 2 is a block diagram showing a train derailment which is one type of infrastructure system emergency.

FIG. 3 is a block diagram showing a blocked railway which is one type of infrastructure system emergency.

FIG. 4 is a flowchart showing a method of operation of an emergency data manager in accordance with various embodiments.

FIG. 5 is a flowchart showing a method of operation of an emergency data manager in accordance with various embodiments.

FIG. 6 is a flowchart showing a method of operation of an emergency data manager in accordance with various embodiments.

FIG. 7 is a message flow diagram showing a method of operation of an emergency data manager in accordance with various embodiments.

FIG. 8 is an example emergency data manager portal graphical user interface (GUI) displayed on an emergency network entity of an emergency communication center (ECC) in accordance with an embodiment.

FIG. 9 is an example of the emergency data manager portal GUI when an alert is accepted by an ECC operator in accordance with an embodiment.

FIG. 10 is an example infrastructure emergency data manager portal GUI displayed on an infrastructure operations center network entity in accordance with an embodiment.

FIG. 11 is an example of the infrastructure emergency data manager portal GUI during creation of an incident by an operator in accordance with an embodiment.

FIG. 12 is an example of the infrastructure emergency data manager portal GUI after creation of various incidents by an operator in accordance with an embodiment.

FIG. 13 is an example of the infrastructure emergency data manager portal GUI after selection of an incident from an incident queue by an operator in accordance with an embodiment.

FIG. 14 is an example of the emergency data manager portal GUI when an alert is shared with one or more emergency responders by an ECC operator in accordance with an embodiment.

FIG. 15 is an example of the emergency data manager alert message sent to an emergency responder device when an alert is shared with one or more emergency responders by an ECC operator in accordance with an embodiment.

FIG. 16 is an example of the emergency data manager alert message update sent to an emergency responder device in accordance with an embodiment.

FIG. 17 is a diagram showing training of various infrastructure related machine learning prediction models in accordance with various embodiments.

FIG. 18 is a flowchart showing a method of operation of an emergency data manager in accordance with various embodiments.

### DETAILED DESCRIPTION

Briefly, the present disclosure provides apparatuses, systems, and methods that provide hardware and technology that, among other things, provide a practical application of hardware and technology to solve a problem of dangerous conditions that may arise in infrastructure systems. Such infrastructure systems include, public infrastructure, private infrastructure and combinations thereof. One example of dangerous conditions that may arise is a dangerous condition due to presence of hazardous material. Another example of dangerous conditions that may arise is a dangerous condition due to presence of downed power lines or ungrounded electrical potential. Many other examples exist. Accordingly, data from infrastructure systems is provided to emergency responders such that the emergency responders may protect themselves and the public from dangerous conditions and may handle the dangerous conditions in accordance with accepted established protocols relevant to the specific dangerous condition.

A first aspect of the present disclosure is an emergency management system that includes a cloud server with a network component and at least one processor, operatively coupled to the network component. The at least one processor is operative to: provide a first data interface from the cloud server to an infrastructure operations center, to receive infrastructure emergency data from the infrastructure operations center by the cloud server; provide a second data interface from the cloud server to an information database, to send a query from the cloud server to the information database with the infrastructure emergency data, and to receive infrastructure emergency handling protocol information by the cloud server in response to the query message; provide a third data interface from the cloud server to an emergency communications center network entity, operative to send an infrastructure emergency message to an emergency communication center to initiate dispatch of emergency responders to a location of the infrastructure emergency; and send a message with infrastructure emergency information received via the second data interface to a plurality of emergency responder devices.

In some implementations, the processor may send the message with infrastructure emergency handling protocol information received via the second data interface, to a plurality of emergency responder devices. In some implementations, the processor may cause a data card to be displayed on the emergency responder devices. In some implementations, the processor may send the message to the emergency responder devices at substantially the same time as sending the infrastructure emergency message to the emergency communication center to initiate dispatch of emergency responders to a location of the infrastructure emergency. In some implementations, the processor may send a webhook to the plurality of emergency responder devices. In some implementations, the processor may send the webhook as a preauthorized webhook with a uniform resource locator selectable to provide the infrastructure emergency handling protocol information. In some implementations, the processor may send the infrastructure emergency message having a location and information related to the infrastructure emergency. In some implementations, the processor may send a short-message-service (SMS) message to the emergency responder devices. In some implementations, the processor may send the SMS message to the emergency responder devices with a uniform resource locator. In some implementations, the processor may send the uniform resource locator as a pre-authorized uniform resource locator.

Another aspect of the present disclosure is a cloud server computer system that has executable instructions for execution by the cloud server computer system, that when executed cause the cloud server computer system to be operative to: communicate with various infrastructure operations center network entities to obtain infrastructure condition information, where the infrastructure condition information is associated with at least one of the various infrastructure operations center network entities; communicate with various emergency communications center network entities to send infrastructure emergency information related to the various infrastructure conditions, to request dispatch of emergency responders to an infrastructure emergency; and transmit infrastructure emergency handling protocol information to a plurality of emergency responder devices in response to receiving infrastructure conditions.

In some implementations, the cloud server computer system is further operative to: provide an instance of an emergency data management application to at least one of the emergency communications center network entities via a first web browser executed on the at least one emergency communications center network entity, with a first graphical user interface (GUI) for display on the at least one emergency communications center network entity; and provide an instance of an infrastructure emergency data management application to at least one of the infrastructure operations center network entities via a second web browser executed on the at least one infrastructure operations center network entity, with a second graphical user interface (GUI) for display on the at least one infrastructure operations center network entity.

In some implementations, the cloud server computer system is further operative to: receive infrastructure condition information related to an infrastructure emergency; send an emergency infrastructure emergency message with the infrastructure condition information to a specific emergency communications center in response to receiving the infrastructure condition information, to request dispatch of emergency responders; and transmit infrastructure emergency handling protocol information to a group of emergency responder devices associated with the specific emergency communications center. In some implementations, the cloud server computer system is further operative to: transmit infrastructure emergency handling protocol information comprising hazardous material handling protocol information. In some implementations, the cloud server computer system is further operative to: provide the first GUI and the second GUI each comprising an emergency alert queue. In some implementations, the cloud server computer system is further operative to: provide the first GUI and the second GUI each comprising a map view along with the emergency alert queue, the map view comprising at least one location indicator corresponding to a location of an infrastructure emergency. In some implementations, the cloud server computer system is further operative to: provide the first GUI and the second GUI each comprising an emergency alert queue comprising icons for representation of a train derailment, and a train blocked crossing. In some implementations, the cloud server computer system is further operative to: provide the first GUI and the second GUI each comprising an emergency alert queue comprising icons for representation of a hazardous material incident. In some implementations, the cloud server computer system is further operative to: determine an event type for each emergency alert queue entry as an event type selected from the group of: a fire emergency event, a police emergency event, a medical emergency event, a train derailment, a train blocked crossing, a hazardous material incident; and push the event type to the first GUI and to the second GUI.

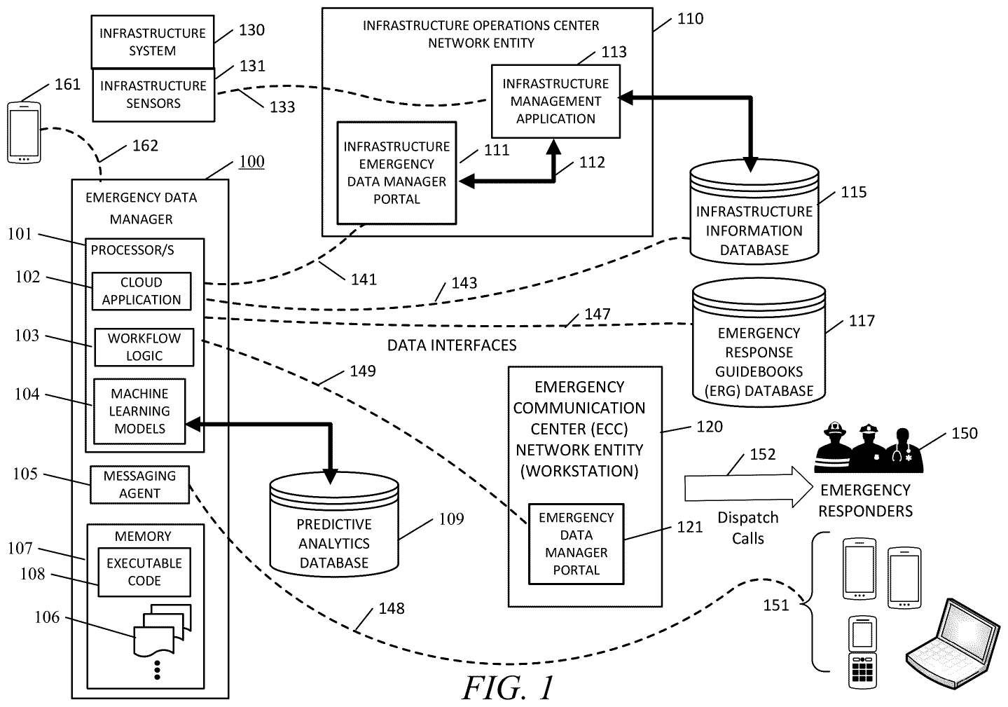

Turning now to the drawings wherein like numerals represent like components, FIG. 1 is a diagram illustrating an infrastructure emergency management system that includes an emergency data manager 100 in communication with various infrastructure systems 130 and sensors 131, various emergency communication centers (ECCs) 120, mobile devices 161, and emergency responder devices 151. The term “ECC” includes Public Safety Answering Points (PSAPs) that handle police, fire, and medical emergencies.

The emergency data manager 100 includes at least one processor 101 and non-transitory, non-volatile memory 107 that stores executable code 108. The executable code 108 (also referred to as “executable instructions,” “code,” “software code,” etc.) when executed by the processor/s 101 provides a cloud application 102, workflow logic 103 and machine learning models 104. A messaging agent 105 may also be present and may be implemented as hardware, software or a combination thereof. The messaging agent 105 may be a short-message-service (SMS) multimedia message service (MMS) agent. In other embodiments, the messaging agent 105 may be a Google Rich Business Messaging (RBM) agent, Apple Business Chat agent, (i.e. chat agents), or an equivalent, etc., that provides “real time message sessions” such as instant messaging (IM) and chat, in which all participants are online and receive and respond to immediate messages, and these messages provide a status indication, such as but not limited to an indication that a participant is typing, online, etc. Rich messaging also enables users to share interactive messages and attach high-resolution images, videos, voice messages, GIFs, etc. to enhance communication of information as compared to legacy SMS/MMS technology. In the various embodiments, the messaging agent 105 facilitates messages with the responder devices 151 via network connections 148 which may be established via SMS/MMS network infrastructure, Internet connections if an RBM or other chat agent is used, etc. Various machine learning models may also be stored in memory 107 as machine learning model executable code 106 that when executed by the processor/s 101 implement that machine learning models 104. Each infrastructure system serviced by the emergency data manager 100 may have one or more machine learning models that is uniquely trained for specific infrastructure systems, or for specific infrastructure system types. For example, one or more machine learning models may be trained for railway systems, while one or more machine learning models may be trained for electrical utility systems, and the like, etc.

The processor/s 101 may be implemented as one or more microprocessors, such as a system on a chip (SoC), or using one or more, or combinations of, ASICs, FPGAS, microcomputers, microcontrollers, digital signal processors, central processing units, state machines, logic circuitries, and/or devices that manipulate signals based on operational instructions. Among other capabilities, the processor 101 is configured and operative to fetch and execute the computer-readable instructions (i.e. executable code 108) stored in the memory 107. For example, the executable code 108, when executed by the processor 101 renders the processor operative to provide a kernel, libraries (i.e. application programming interfaces or “APIs”), an application layer or “user space” within which the various applications are executed, and an IP protocol stack. The applications executable code 108, when executed by the at least one processor 101, may also provide the workflow logic 103, machine learning models 104 and messaging agent 105. The processor 101 is operative to perform the various methods of operation of an emergency data manager 100 as described herein including, but not limited to, the methods of operation disclosed herein and described with respect to various flowcharts provided in the drawings. In some embodiments, the emergency data manager 100 may be implemented using one or more cloud servers that provide the cloud application 102 to various ECCs such that there is redundancy and system reliability in the event of failure of any one cloud server.

The infrastructure system 130 may be any infrastructure system such as systems related to transport infrastructure such as roads, rail, cable, and shipping ports; aviation infrastructure such as air traffic control technology; rail transport such as trackage, signals, electrification of rails; road transport such as roads, bridges, tunnels; critical infrastructure such as assets required to sustain human life; energy infrastructure such as transmission and storage of fossil fuels and renewable sources; electrical grid such as transmission and distribution stations, power lines, power plants, etc.; hazardous waste such as disposal and handling; information and communication infrastructure such as systems of information storage and distribution; solid waste such as generation, collection, management of trash, garbage and recycling; water infrastructure for the distribution and maintenance of water supply; wastewater infrastructure for disposal and treatment of wastewater, etc.

The infrastructure system 130 includes various infrastructure sensors 131 that provide data related to the infrastructure system 130 to a point of control, such as an infrastructure operations center (IOC) which includes one or more network entities such as infrastructure operations center network entity 110 (IOC network entity 110). The IOC network entity 110 includes an infrastructure management application 113 that is operation to communicate with the infrastructure system 130 and to receive data from the infrastructure sensors 131.

The cloud application 102 is operation to provide single tenant, or multi-tenant cloud applications for emergency management to multiple IOC network entities and for a variety of different infrastructure systems. The cloud application 102 provides each cloud application instance via an infrastructure emergency data manager portal 111 (IEDM portal 111) which provides a graphical user interface GUI to the operator of the IOC network entity 110. The IOC network entity 110 may be, for example, a workstation, laptop computer, etc. Each infrastructure system 130 may have multiple IOC network entities 110 operated by different operators and each operator may execute an instance of the cloud application 102 via the IEDM portal 111 and GUI.

In some embodiments, the IEDM portal 111 may be operatively coupled to the infrastructure management application 113 (IMA 113) via an application programming interface 112 (API 112) to receive data from the infrastructure sensors 131, or to receive other information and data from the IMA 113. The IMA 113 may also be operatively coupled to an infrastructure information database 115 that contains information related to the infrastructure. The IEDM portal 111 operates via a data interface 141 to the cloud application 102, which may be a web socket connection over a TCP/IP connection, or may be an API data interface in some embodiments.

The emergency data manager 100 is operative to receive data from mobile devices 161 that have placed emergency calls or texts to an ECC by for example, dialing 9-1-1, or equivalent 1-1-2, etc. When a mobile device 161 places an emergency call to an ECC the mobile device 161 sends hybrid location data over a data interface 162 which may be an Internet connection and may involve one or more intermediate cloud servers. The emergency data manager 100 receives the hybrid location data (which may include mobile device 161 GPS location and also mobile device 161 generated/calculated location) and sends the location information and a mobile device identifier (i.e. the mobile device telephone number) to an ECC relevant to the mobile device's location when calling for emergency help. The cloud application 102 is operatively coupled to various ECCs. For example, the cloud application 102 provides an application instance to an ECC network entity 120 via an EDM portal 121 executing within a web browser. The data interface 149 may be a web socket connection over a TCP/IP connection. Multiple ECCs may operate multiple application instances of the cloud application 102 and each network entity may display and operate the EDM portal 121 via the associated GUI.

When the cloud application 102 receives a location and a telephone number from a mobile device 161 when an emergency call is placed, a workflow logic 103 begins operation and forms an emergency message or emergency alert that is sent from the emergency data manager 100 to the relevant ECC based on the location of the caller and the jurisdiction of the ECC. The workflow logic 103 sends the emergency alert to the EDM portal 121 over the data interface 149 for display within the GUI. The mobile device 161 location information received and handled by the emergency data manger 100 is performed independently from the emergency call routing (i.e. independently from the telephony network routing) and does not involve the SS7 or C7 network signaling of the telephony network. Therefore, the mobile device 161 location and telephone number may be displayed within the GUI of the EDM portal 121 prior to the ECC having received and answered the actual call.

For infrastructure emergencies, there are two ways in which an ECC may be informed of the situation. In one case, a bystander who witnesses an emergency may call in to the ECC by, for example, dialing 9-1-1. Another way in which the ECC may be informed is from the IOC network entity 110. An operator, using the IEDM portal 111 may create an incident by entering appropriate identification information into the GUI which is then sent by the emergency data manager 100 to the ECC EDM portal 121. After the incident is created and the corresponding incident information is received at the ECC, an ECC operator may perform dispatch functions to dispatch emergency responders 150 to the incident location.

Because infrastructure emergencies may require special knowledge and special handling, the cloud application 102 is also operatively coupled to the infrastructure information database 115 via a data interface 143, and to an emergency response guidebook (ERG) database 117 by another data interface 147. The data interfaces may be APIs in some embodiments and the databases may utilize SQL etc., or equivalent.

The cloud application 102, in some embodiments, may also be operative to receive data from the infrastructure sensors 131. The cloud application 102 may receive the sensor data 133 directly in some implementations, or may receive data from via the IEDM portal 111 via API 112. The machine learning models 104 use sensor data 133 from the infrastructure sensors 131 and emergency data received from the IEDM portal 111 and correlates the sensor data 133 with the emergency data to predict infrastructure emergencies and obtain other analytical insights. The predictions and analysis may be stored in the predictive analytics database 109 as reports and other information.

As used herein, components may be “operatively coupled” when information can be sent between such two components, even though there may be one or more intermediate or intervening components between, or along the connection path. Operative coupling may exist between engines, system interfaces or components implemented as software or firmware executing on a processor and such “software coupling” may be implemented using libraries (i.e. application programming interfaces (APIs)) or other software interfacing techniques as appropriate. Such libraries or APIs provide operative coupling between various software implemented components in FIG. 1.

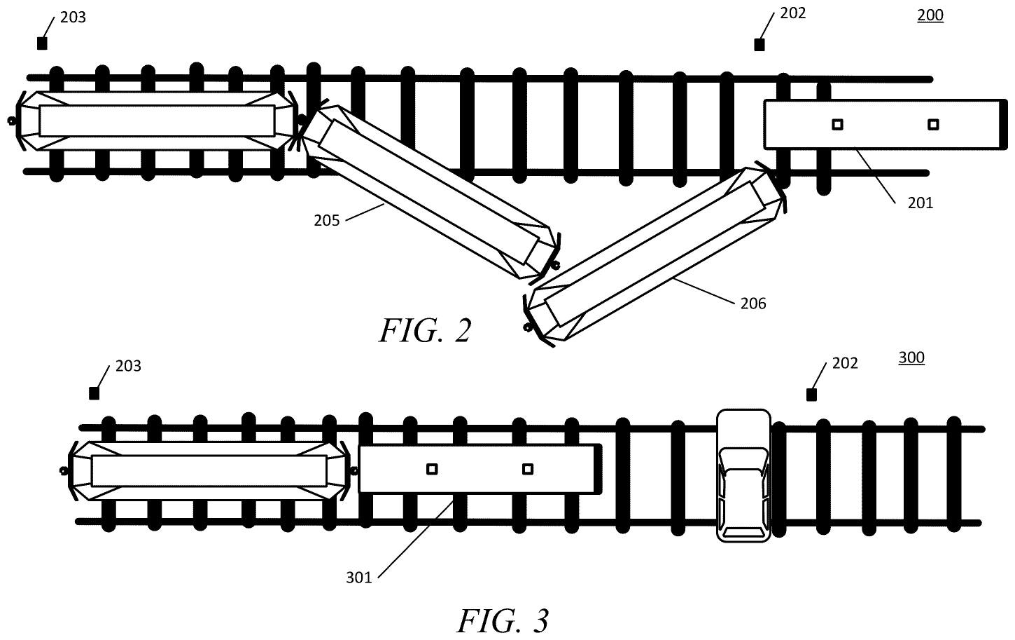

FIG. 2 is a diagram showing a freight train derailment incident 200 which is one type of infrastructure system emergency. Typically, a freight train has an engineer and a conductor. If there is a derailment, the conductor will usually exit the train and perform a “walkabout” to access the situation. An emergency responder will normally also walk along the train track at the derailment and look for numbers on the side of the railcars. The railcar numbers may enable the emergency responder to obtain information about the contents or materials within the railcars. A freight train could be two or more miles long. Therefore, the emergency responder has to walk the two or more miles down and back along the train track to access the situation. A danger in this situation is that an emergency responder could possibly be walking into a hazardous material incident where toxic material is soaking into their clothing or getting into their lungs. In accordance with the embodiments, the emergency responders are armed with the knowledge of the railcar contents in such a situation and information required for handling the material and how to contain it.

In the case of railways, the IOC network entity 110 may be referred to as a Network Operating Center (NOC), which, for freight rail management, is somewhat analogous to an air traffic controller system. A PTC (Positive Train Control) or the like system emits signals back to the NOC about the condition of the train. Sensors on board and off board a train may send information to the IMA 113. For example, with reference to FIG. 2, mile marker 202 and mile marker 203 may detect when a train passes the markers and send this information back to the IMA 113. By analysis of the time between detections, the IMA 113 may detect anomalies such as incorrect speed, an unscheduled stop, time spent at a given stop, etc. In FIG. 2 rail car 205 and rail car 206 have “jackknifed” and are in a sever derailment situation. The mile marker 203, mile marker 202 and other mile markers may be used to determine at least that the train has stopped and is no longer progressing, and may also may able to discern a change in the overall length of the train due to the jackknifed cars. For example, if the engine and caboose are detectable via the mile markers, or other sensor technologies, the train length may be determinable.

In addition to derailments, trains may also experience blocked tracks where the train tracks are blocked by debris, a cow or other animal, a person, vehicles including stalled cars and, in some cases, cars placed on the track deliberately. FIG. 3 is a diagram showing a blocked railway incident 300, which is another example type of infrastructure system emergency. In this situation, the mile marker 203 may detect presence of the train and mile marker 202 may be used to determine that the train has not passed by at the expected time interval. Because this would be an anomaly, a conclusion may be drawn that the track is blocked or that the train is experiencing some other technical problem. The machine learning models 104 may be invoked and may provide a prediction of the actual problem occurring based on sensor data 133 from infrastructure sensors 131. The IEDM portal 111 may display the predicted problem within the GUI.

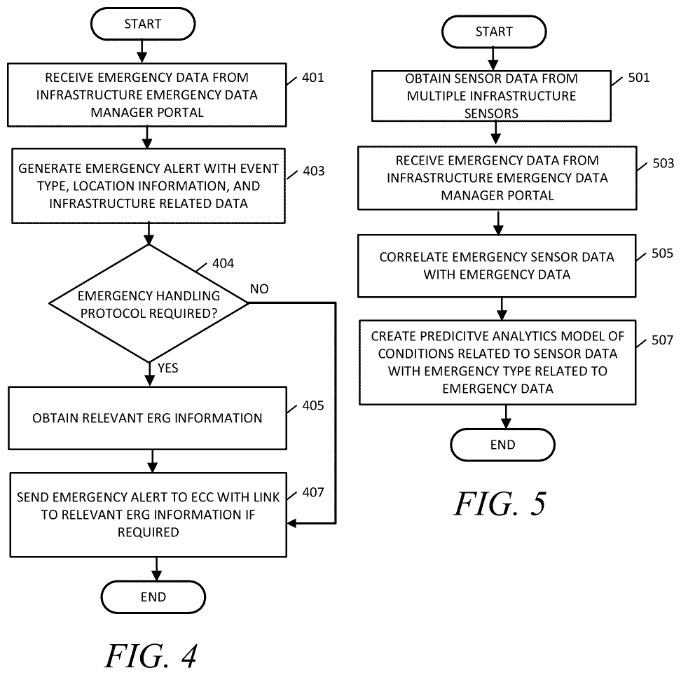

FIG. 4 is a flowchart showing a method of operation of an emergency data manager 100 in accordance with various embodiments. The method of operation begins, and in operation 401 the emergency data manager 100 receives emergency data from the IEDM portal 111 GUI. In response to receiving the emergency data, in operation 403, the cloud application 102 invokes workflow logic 103 which generates an emergency alert with an event type, location information, and infrastructure related data. The emergency alert is sent to an ECC that has jurisdiction of the emergency based on the location contained in the emergency data received in operation 401. In decision operation 404, the emergency data manager 100 determines whether an emergency handling protocol is required. For example, if a hazardous material is involved, then an emergency response guidebook (ERG) may be required for handling the situation. If an ERG is required at decision operation 404, then in operation 405 the emergency data manager 100 obtains the relevant ERG from an ERG database 117. In operation 407, the emergency data manager 100 sends the emergency alert generated in operation 403 to the ECC, along with a link to the ERG information if it is required. If no ERG information is required at decision operation 404, then the method again proceeds to operation 407 and sends the emergency alert to the ECC. Emergency responders may also be sent a pre-alert link to their mobile devices that provides them with information about the infrastructure emergency and a link to the ERG if required. The method of operation then ends as shown.

FIG. 5 is a flowchart showing a method of operation of an emergency data manager in accordance with various embodiments. The method of operation begins at operation 501 and the emergency data manager 100 receives sensor data from multiple infrastructure sensors 131. The sensors may be, for example, railway system speed data, wheel temperature, mile marker information; electrical grid supervisory control and data acquisition (SCADA) system information (such as information about power outages, short circuits, downed power lines, etc.); water system data indicating water main bursts etc. and other types of information related to various infrastructure systems. In operation 503, the emergency data manager 100 receives emergency data from various infrastructure operations centers from an IEDM portal 111 GUI executing an instance of the cloud application 102 at the infrastructure operation center. In operation 505, the emergency data manager 100 correlates the sensor data 133 with the emergency data. In operation 507, the emergency data manager 100 builds a predictive analytics model as machine learning models 104 that can be used to predict future infrastructure emergencies based on sensor data 133 from the infrastructure sensors 131. The machine learning models 104 may include more than one type of machine learning model for each infrastructure system. In some embodiments, some of the machine learning models 104 may be deep learning models (such as an artificial neural network, or a convolutional neural network) and may be a GPT such as a large language model (LLM) in some embodiments. In some embodiments, some of the machine learning models 104 may be decision tree models or random forest models that may be used to predict situations based on the sensor data 133 and emergency data received by the ECC. The machine learning models 104 may be trained using labeled training data that is a combination of sensor data 133 and emergency data collected over an interval of time, for example several months or years, using data from IOC network entities and ECC network entities such that the machine learning models 104 can develop correlative relationships between the infrastructure situation, the sensor data 133, and emergency data received at the ECC.

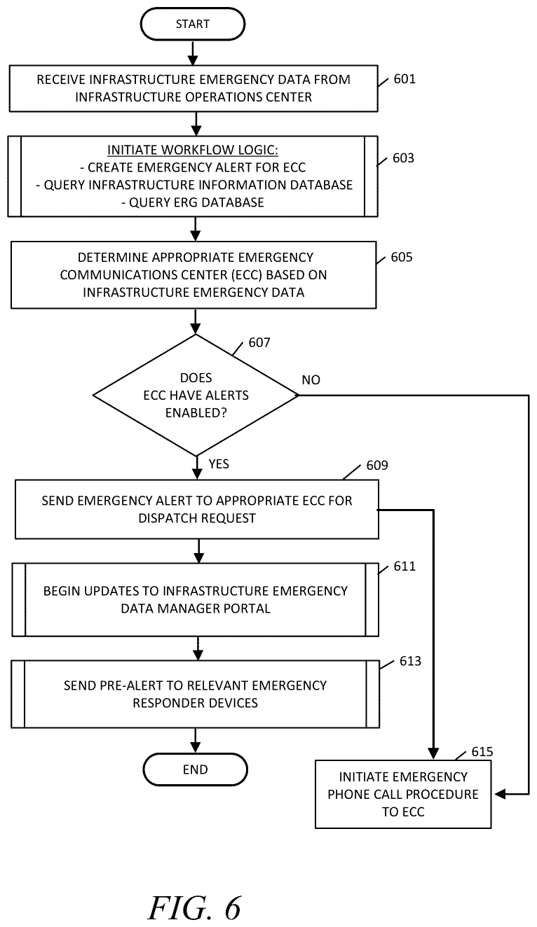

FIG. 6 is a flowchart showing a method of operation of an emergency data manager 100 in accordance with various embodiments. In operation 601, the emergency data manager 100 receives emergency data from an infrastructure operation center network entity 110 via an instance of the cloud application 102 provided by an IEDM portal 111 GUI. The emergency data includes information about the nature or type of emergency, and a location. For example, in a freight train derailment situation, the emergency data would include a train identifier, and location which would correspond to either the freight train engine position or the freight train caboose position.

In operation 603, the emergency data manager 100 initiates workflow logic 103 which performs several operations. One operation is preparation of an emergency alert to be sent to an ECC. The relevant ECC is determined by using the location received in the emergency data. The workflow logic 103 also initiates a query to the infrastructure information database 115 to obtain further information. For example, in a railway emergency situation, a train identifier may be provided in the emergency data sent from the IEDM portal 111 GUI. The workflow logic 103 may then use the train identifier to query the infrastructure information database 115 to obtain the “consist” which is information as to each railcar of the freight train and the cargo of each of the railcars. In some cases, the freight train consist will indicate that one or more of the railcars contains hazardous material. If the workflow logic 103 receives an indication of hazardous material in the consist, it will query the ERG database 117 to obtain the relevant ERG information.

In operation 605, the workflow logic 103 will determine the relevant ECC based on location. In some situations, a freight train may be two or more miles long and therefore a derailment or other situation may cross two or more ECC jurisdictional boundaries. In that case, the emergency data manager 100 may send an emergency alert to each of the ECCs that may need to be involved in resolution of the emergency. Therefore, in operation 605 the workflow logic 103 may determine that multiple ECCs will receive the emergency alert.

Each ECC has the capability to turn certain emergency alerts on or off using their respective EDM portal GUI 121. Therefore, at decision operation 607, the workflow logic 103 determines whether the ECC has emergency alerts enabled. If the ECC has emergency alerts enabled, then in operation 609 the emergency data manager 100 sends the emergency alert to the appropriate ECC, or ECCs, to request dispatch or emergency responders.

In operation 611 the workflow logic 103 begins to send updates to the ECC and to the infrastructure operation center by way of the EDM portal GUI 121 and IEDM portal 111 GUI, respectively. In operation 613 the workflow logic 103 may send a pre-alert to one or more emergency responder devices 151 with information about the infrastructure emergency.

If at decision operation 607 the relevant ECC has emergency alerts disabled, the workflow logic 103 sends a message to a call center in operation 615 to initiate an emergency phone call procedure from the call center to the ECC.

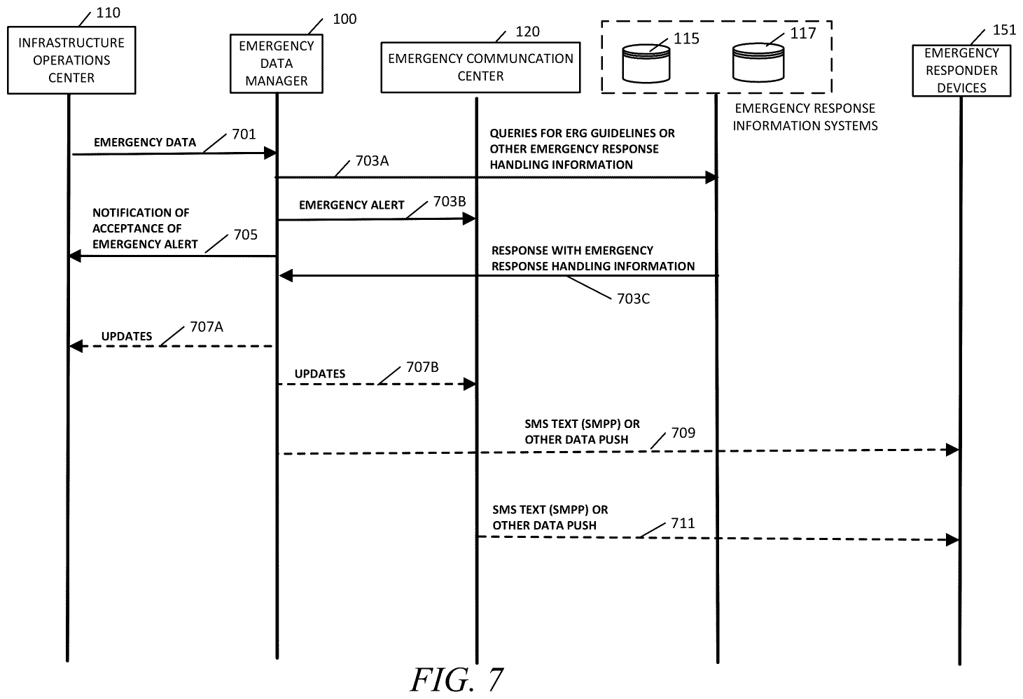

FIG. 7 is a message flow diagram showing a method of operation of an emergency data manager 100 in accordance with various embodiments. The infrastructure operations center 110 sends emergency data 701 to the emergency data manager 100. In response to receiving the emergency data 701, the emergency data manager 100 sends a query message 703A to emergency response information systems (i.e. infrastructure information database 115 and ERG database 117) to retrieve additional information related to the emergency data 701. In the example of a freight train derailment incident, the additional information may be freight train consist data which provides railcar numbers and the cargo of each of the railcars including any hazardous materials. The emergency data manager 100 also sends an emergency alert 703B to the relevant ECC 120 based on a location of the incident. The emergency data manager 100 may then receive an acknowledgment of acceptance of the emergency alert 703B from the emergency communication center 120. The emergency data manager 100 may then send a notification of acceptance of the emergency alert 705 to the infrastructure operations center network entity 110.

The emergency data manager 100 receives infrastructure emergency response handling information 703C such as, but not limited to, ERG information from the ERG database 117. In the case of a freight train derailment, the infrastructure emergency response handling information 703C will also include freight train consist data. The emergency data manager 100 then sends updates 707A to the IEDM portal 111 GUI at the IOC network entity 110 and sends updates 707B to the EDM portal GUI 121 at the ECC network entity 120. The emergency data manager 100 may also send a pre-alert message 709 to one or more emergency responder devices 151. One way this may be accomplished is via the messaging agent 105. Another way is via an application operating on each of the emergency responder devices 151. The ECC for example may control one or more lists of emergency responders it wishes to send certain types of pre-alert messages to for certain incidents. The emergency responders 150 have accounts with the application and their emergency responder devices 151 have account information at the ECC associated with the application. The ECC may then specify either a device identifier (such as a mobile phone number) or a group identifier for a list of phone numbers for the emergency responder devices 151 that are to receive the pre-alert messages. The application then communicates with the emergency data manager 100 through an API or communicates with the EDM portal GUI 121 via a different API to obtain the information to be included in the pre-alert and the application pushes the pre-alert message to the emergency responder devices 151 as pre-alert message 711.

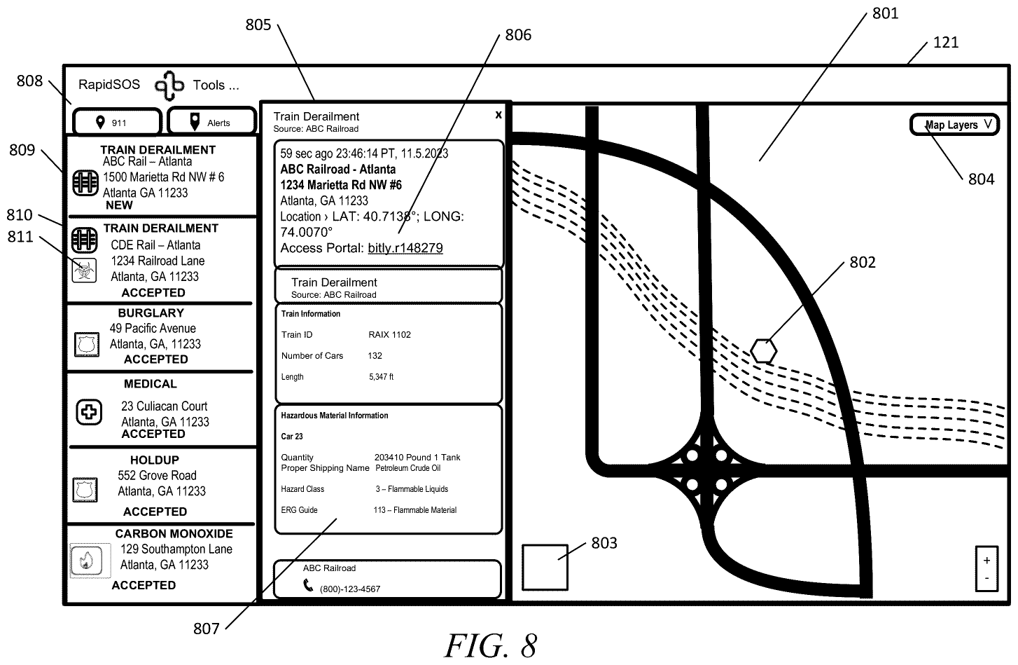

FIG. 8 is an example EDM portal GUI 121 displayed on an ECC network entity 120 in accordance with an embodiment. The EDM portal GUI 121 includes a map view 801 that show an area of jurisdiction of the ECC. An area of jurisdiction refers to one or more geographic areas, having a boundary that is typically polygonal, for which the particular ECC has authority and responsibility for handling emergencies. The map view 801 may include various layers that may be turned on and off using map layers control 804. The map view 801 may also have a satellite view control 803 that may be turned on and off, as well as other controls to zoom in and zoom out of the map view 801. One or more location indicators 802 may be displayed that show emergency locations and may provide other information such as emergency type, severity, whether the emergency is being handled, etc. and this information may be provided by text, fonts, colors, icon shape and size, flashing indications, etc. and any combination of these features.

An emergency queue also provided with various queue entries for emergencies that have been sent by the emergency data manager 100, incoming emergency calls, or both. In some implementations, the operator may have selectable tabs 808 to switch between an emergency call (i.e. 9-1-1 or 1-1-2 calls) queue and an emergency alerts queue. Alert queue entries are selectable and enable display of further detailed information. For example, alert queue entry 809 is for a train derailment and may be selected to show a data card 805. The data card 805 may provide a link, such as a uniform resource locator (URL) or shortened URL 806 that provides even more detailed information. If hazardous material is involved, the data card 805 may have a hazardous material information field 807.

Each of the emergency alerts queue entries may show one or more icons that indicate the type of incident related to the entry. For example, emergency alert queue entry 809, which is for a train derailment, shows a train track icon. Example, emergency alert queue entry 810, which is for a train derailment involving hazardous material, shows a train track icon and a hazardous material icon 811. The icons may be of any size or shape, may utilize various colors and may be flashing. The emergency alerts queue entries also indicate if the entry has been accepted by an ECC operator, or whether the entry is new and needs to be accepted and handled.

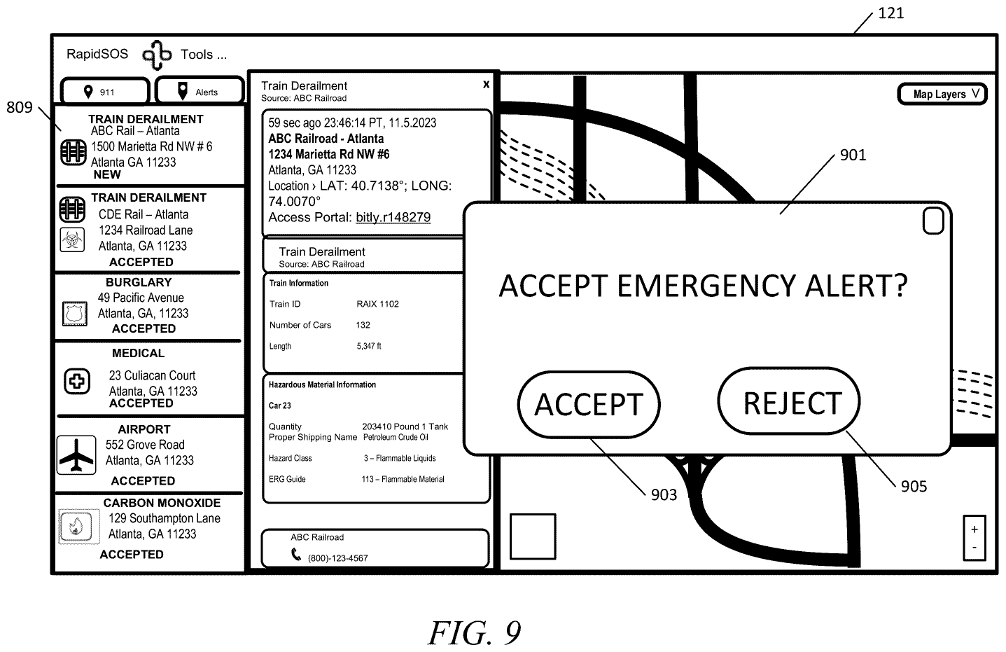

FIG. 9 is an example of the EDM portal GUI 121 when an emergency alert queue entry is selected and is accepted by an ECC operator in accordance with an embodiment. For example, if the ECC operator selects the emergency alert queue entry 809, which indicates that it is a “NEW” emergency alert entry, a dialogue box 901 will pop-up overlaying the primary EDM portal GUI 121 as shown. The operator then may accept the emergency alert by selecting the “ACCEPT” button 903 or reject the emergency alert by selecting the “REJECT” button 905. If the emergency alert queue entry is accepted by the ECC operator, then the status of the emergency alert queue entry is changed from “NEW” to “ACCEPTED.” Other ECC operators that are running an instance of the cloud application 102 will also see this change in the emergency alert queue entries in their specific instantiation of the EDM portal GUI 121. This way, in an ECC having multiple operators, each operator has knowledge of when a queue entry needs addressing or whether it is already being handled by another ECC operator.

If the ECC operator rejects the queue entry, several procedural events may occur depending on the specific operational procedures of the ECC. In one example implementation, rejection of an emergency alerts queue entry removes the entry in the EDM portal GUI 121 instance for the specific ECC operator but does not remove it from the queue of other operator instances. In other words, the entry remains NEW and active until another ECC operator eventually accepts the entry. In a multiple ECC scenario where multiple ECC could potentially have responsibility for an emergency alert entry, rejection of the entry removes the entry from the entire ECC such that another ECC must accept and respond to the emergency alert entry. In these situations, the emergency data manager 100 handles the updates to the respective EDM portal GUI 121 instances at the various ECCs and any involved infrastructure operations centers.

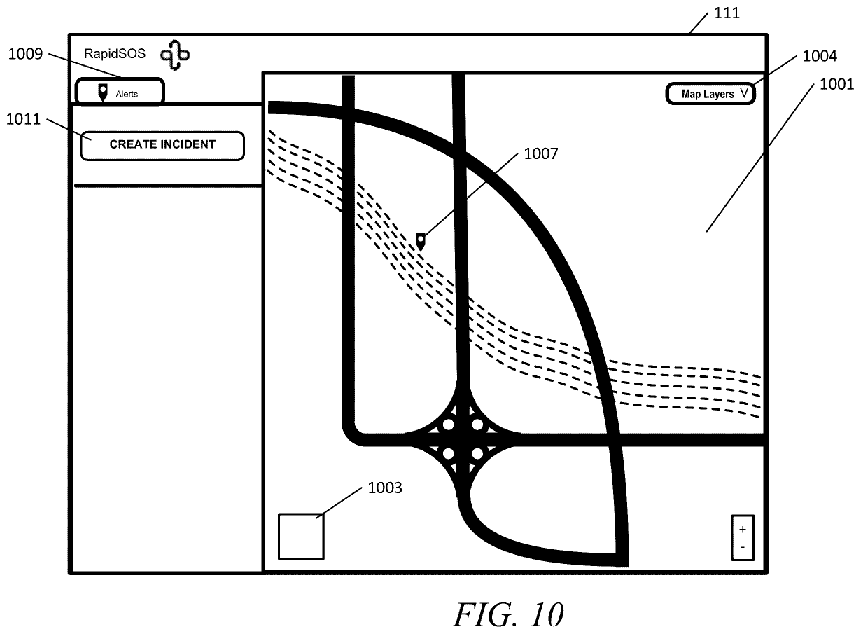

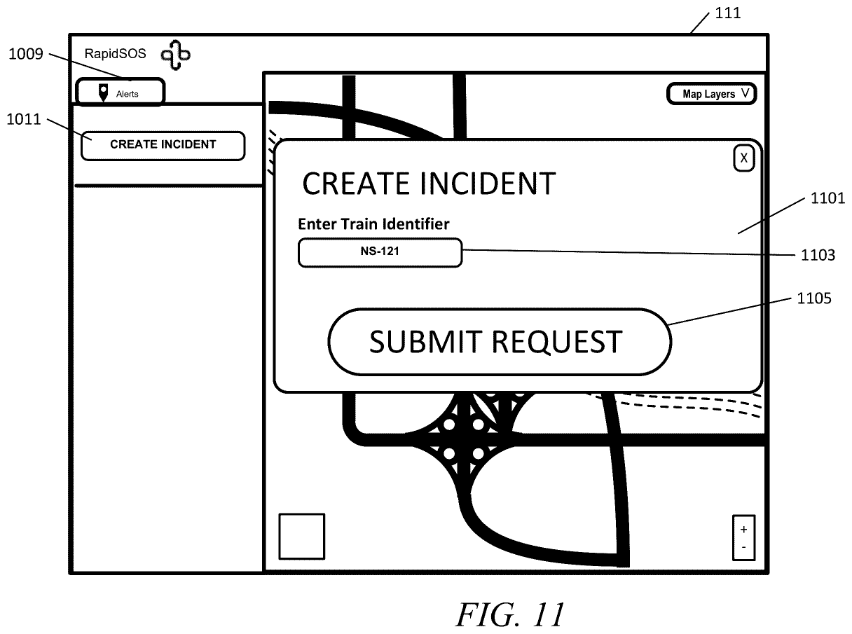

FIG. 10 is an example IEDM portal 111 GUI displayed on an infrastructure operations center network entity 110 in accordance with an embodiment. The IEDM portal 111 GUI includes a map view 1001 that is operative to show one or more geographic areas that involve infrastructure related to the infrastructure operations center. For example, if the IOC is a NOC for a railway system, then the map view 1001 will be operative to show areas of railway, train yards etc. operated by that NOC. Similar to the ECC EDM portal, the IEDM portal 111 GUI may include various layers that may be turned on and off using map layers control 1004, and may also have a satellite view control 1003 that may be turned on and off, as well as other controls to zoom in and zoom out of the map view 1001. One or more location indicators 1007 may be displayed that show emergency locations and may provide other information such as emergency type, severity, whether the emergency is being handled, etc. and this information may be provided by text, fonts, colors, icon shape and size, flashing indications, etc. and any combination of these features. The IEDM portal 111 GUI will have an alerts queue with a selectable alerts queue tab 1009 and a “CREATE INCIDENT” button 1011. Selection of the CREATE INCIDENT button 1011 by the IOC operator invokes the GUI screen shown in FIG. 11.

FIG. 11 is an example of the IEDM portal 111 GUI when the IOC is a NOC during creation of a train related incident by an operator in accordance with an embodiment. Selection of the CREATE INCIDENT button 1011 invokes the popup dialogue box 1101 which includes a train identifier field 1103 and a SUBMIT REQUEST button 1105. Closing the dialogue box 1101 cancels the request. If the operator enters a train identifier into the train identifier field 1103 and selects the SUBMIT REQUEST button 1105, the incident is sent to the emergency data manager 100 and to the cloud application 102 which invokes the workflow logic 103 to create an emergency alert to be sent to an appropriate ECC among other actions.

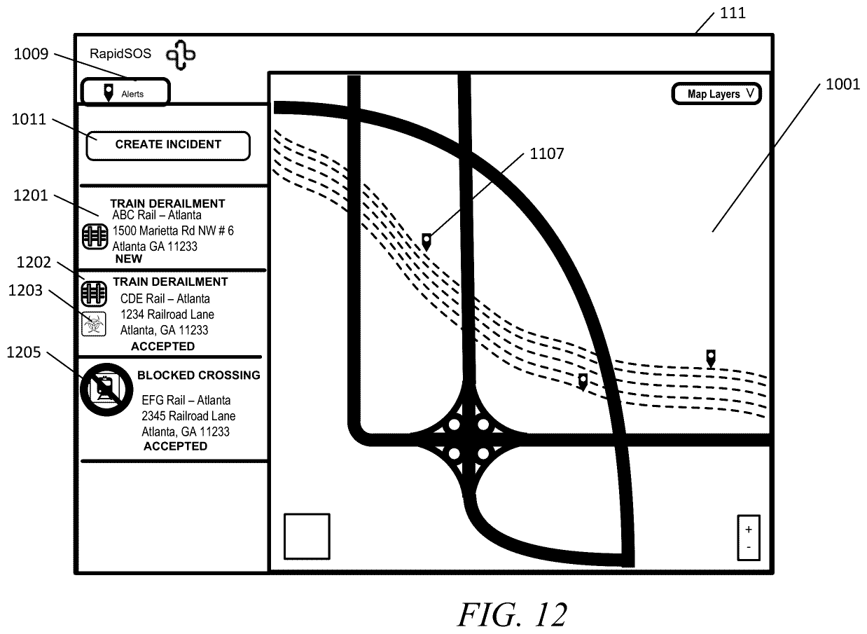

FIG. 12 is an example of the IEDM portal 111 GUI after creation of various incidents by an operator in accordance with an embodiment. After the operator creates the incident, it will appear in the alerts queue similar to example alerts queue entry 1201 with a “NEW” indicator. Any other previously created incidents will also appear in the alerts queue. Similar to the EDM portal GUI, for the IEDM portal 111 GUI, each of the emergency alerts queue entries may show one or more icons that indicate the type of incident related to the entry, however entries will be relevant to the specific infrastructure operations center. For example, if the IOC is a NOC for a railway, the alert queue entries will be railway related. For example, emergency alert queue entry 1201, which is for a train derailment, shows a train track icon. The second example emergency alert queue entry 1202, which is for a train derailment involving hazardous material, shows a train track icon and a hazardous material icon 1203. Example emergency alert queue entry 1205, which is for a blocked train track crossing, shows a blocked train icon. The icons may be of any size or shape, may utilize various colors and may be flashing. The emergency alerts queue entries also indicate if the entry has been accepted by an ECC operator at the ECC to which the emergency alert was sent by the emergency data manager 100. In other words, the IEDM portal 111 GUI is updated by the emergency data manager 100 from time-to-time as the situation evolves. The map view 1001 shows a location indicator 1107 for each of the entries in the alert queue, and the position of the location indicators 1107 may also be updated from time-to-time. Depending on the geographic coverage of the specific infrastructure system, and the locations of the incidents in the alerts queue, not all location indicators may be present in the map view 1001. However, selection of an entry in the alerts queue will move the map view 1001 to a position such that the related location indicator 1107 is shown. Also, the IOC operator can position the map view 1001 to any specific location desired.

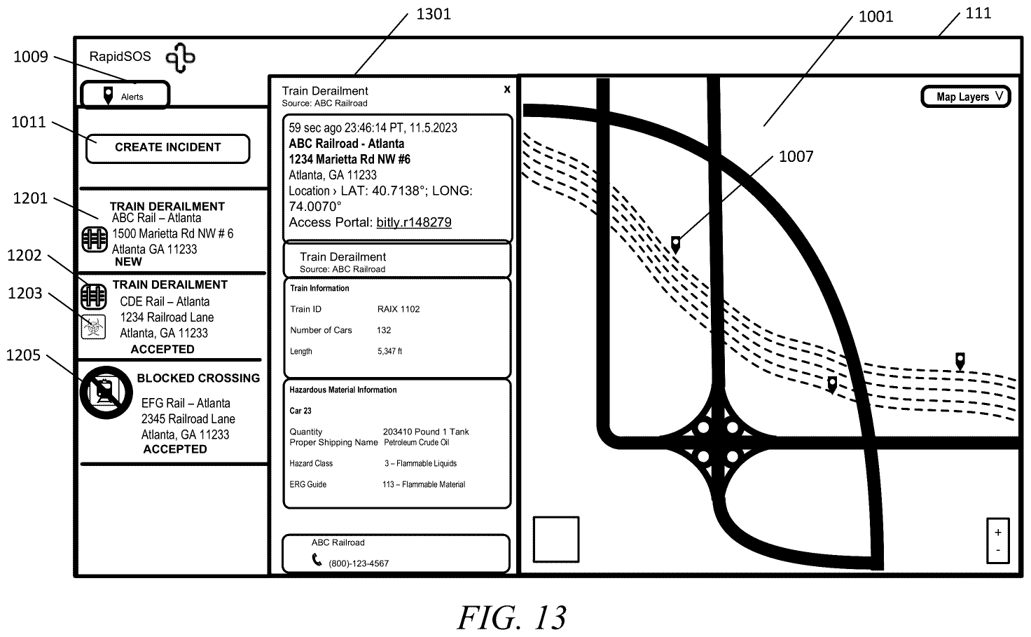

FIG. 13 is an example of the IEDM portal 111 GUI after selection of an incident from the alert queue by an operator in accordance with an embodiment. For example, selection of entry 1203 results in display of popup data card 1301 showing information about the incident including hazardous material information. The map view 1001 will show a location indicator 1007 associated with the incident and may be highlighted by color, brightness, size, or some other visual indication that it is the location indicator associated with the selected incident from the alert queue and associated with data card 1301.

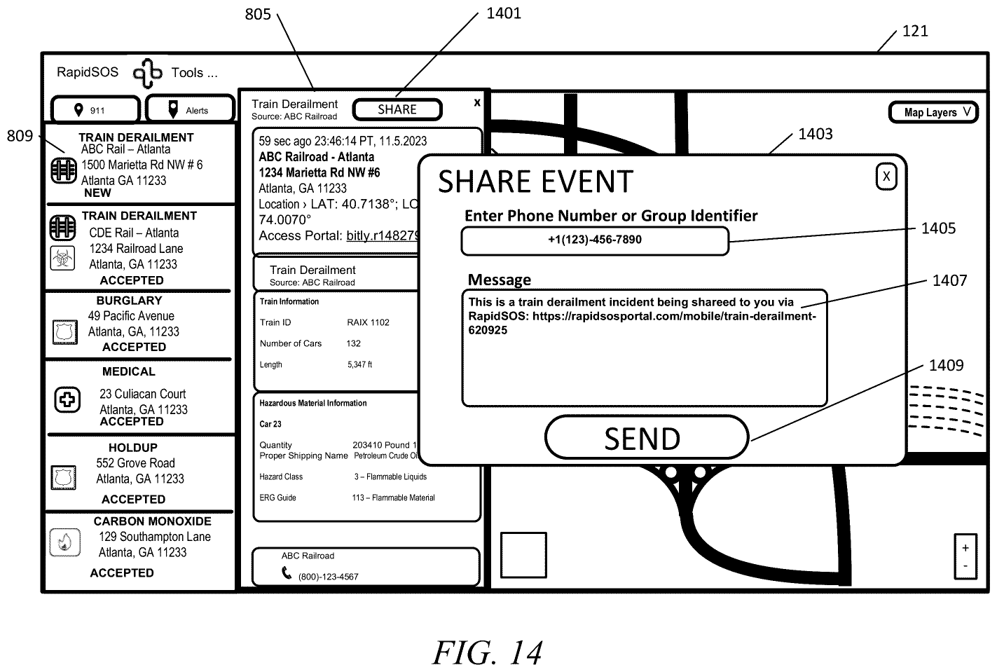

Returning to the ECC EDM portal GUI 121, FIG. 14 is an example of the EDM portal GUI 121 when an alert is shared with one or more emergency responders by an ECC operator in accordance with an embodiment. Selection of an alert queue entry such as example alert queue entry 809 invokes the popup data card 805 which further includes a “SHARE” button 1401. Selection of the SHARE button 1401 invokes a popup dialogue box 1403, which includes a phone or group identifier field 1405, a message field 1407 and a SEND button 1409. In some implementations, the phone or group identifier field 1405 may be a pulldown menu of prepopulated phone numbers, group lists or both phone numbers and group listings, that may be selected for sharing the event. The message field 1407 may, in some implementations, be pre-populated with an editable entry related to the selected incident. For example, because the operator selected alert queue entry 809 which is for a train derailment, the pre-populated message is related to the train derailment and includes a URL to further information that the emergency data manager 100 obtained at the time of creation of the incident by the IOC operator. The SHARE EVENT dialogue enables sending a pre-alert message to emergency responder devices 151 with information to make the emergency responders aware of the situation even before a dispatch call is made to the emergency responders. Selection of the SEND button 1409 sends the pre-alert to the selected phone number, or group.

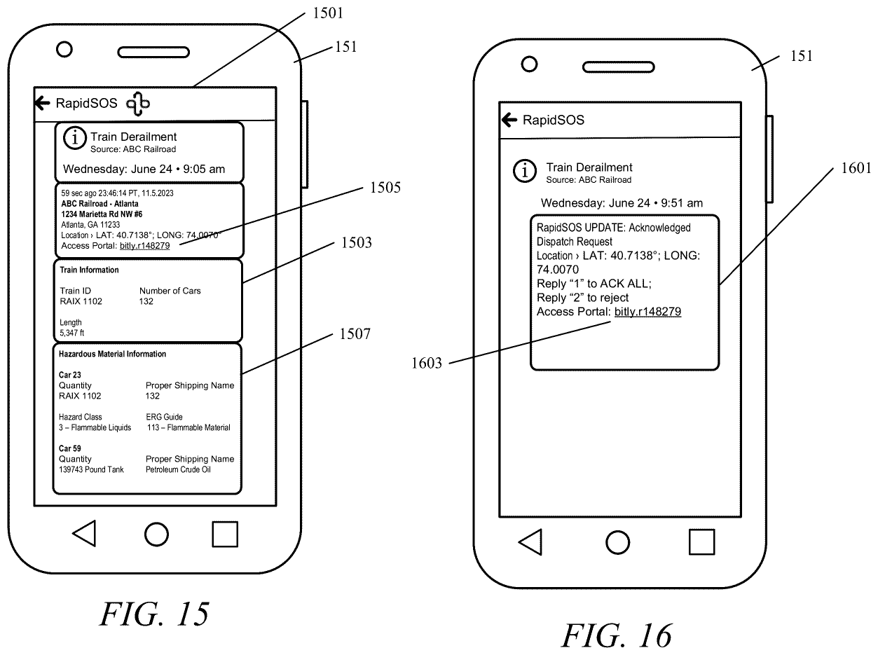

FIG. 15 is an example of the emergency data manager alert message sent to an emergency responder device 151 when an alert is shared with one or more emergency responders by an ECC operator after selection of the SEND button 1409 in accordance with an embodiment. The pre-alert message 1501 is displayed on an emergency responder device 151 and may include infrastructure specific information 1503 and a preauthorized URL 1505 linking to other pertinent information. The term “pre-alert message” is used because the message may be sent prior to a formal dispatch request. However, the message may also be sent as part of a dispatch request, or after a dispatch request in accordance with the various embodiments.

In one specific example of a train derailment incident, the infrastructure specific information 1503 may include a train identifier, the number of railcars, the length of the train and other information. If hazardous material is involved, the pre-alert message 150 may include hazardous material information 1507.

FIG. 16 is an example of the emergency data manager 100 alert message update sent to an emergency responder device in accordance with an embodiment. After an alert message, or pre-alert message, is sent to an emergency responder device 151, updates may be sent such as example update message 1601. The update message may also provide a preauthorized URL 1603 that may be selected by the emergency responder to obtain further information. In one example, if the incident involved hazardous material, the preauthorized URL 1603 may provide a link to an ERG related to the hazardous material. The URL is preauthorized in that, the emergency responder can access the material just by clicking on the link and does not have to login to the system. However, the preauthorized URL 1603 may be limited to a certain number of selection clicks, a certain period of time, or some combination of these limits. The preauthorized URL 1505 in FIG. 15 would have similar limits on access. The preauthorized URL may be sent as a web hook, however it may also be sent as an SMS/MMS message, RCS message, other form of chat message, or via any other suitable mechanism.

Specifically, for railroad incidents, an ECC may need to be contacted for a number of reasons, such as but not limited to, an emergency needing response from local law enforcement, fire department or emergency medical services (EMS). An ECC may also be contacted when an incident has occurred that could adversely affect the public, when a train will be blocking a crossing for an extended period of time (such as longer than 30 minutes), or when railroad police/security personnel request assistance from local law enforcement.

The presently disclosed apparatuses, systems, and methods provide information flow between ECCs and infrastructure operations centers. Specifically, for railways, the presently disclosed apparatuses, systems, and methods may provide information similar to, or in addition to, requirements as set forth in the NENA Public Safety Communications & Railroad Interaction Standard Operating Procedures, NENA-STA-013.2-20116 (Mar. 31,2016).

For example, the emergency data manager 100 may provide an ECC with address, street, community, landmark, longitude, and latitude, etc. The emergency data manager 100 may provide information as to whether a single railcar or multiple railcars were involved in an incident, whether the train involved is still moving or will be stopping, and the planned stop location; the current location of the engine and involved railcars; the current location of the conductor; and the current location of any non-rail vehicles.

Further, the emergency data manager 100 may provide information regarding whether any grade crossings are blocked, estimates of how long grade crossings will be blocked, effected waterways and how they are affected, whether the incident is near a municipality or in a rural area, additional hazards adjacent or within proximity of the incident such as, but not limited to, chemical plants, public facilities, public access areas, visible overhead facilities or structures that may be impacted, barriers to reaching the incident scene that responders need to be aware of, conditions of the tracks, such as but not limited to electrified or damaged rails, etc.

The emergency data manager 100 may also provide information as to the type of incident such as, but not limited to the type of response requested such as law enforcement, fire, medical, or hazmat, including the nature and type of incident. For railways, these may include derailment, train versus motor vehicle, train versus pedestrian/trespasser, fire, hazardous chemicals leak, criminal activity, medical emergency, type of train, estimated number of passengers onboard for passenger trains, freight, consist/manifest information for freight trains, and any other needed information such as track maintenance vehicles or equipment, any known injuries, estimated number and extent of injuries, etc.

In other words, the emergency data manager 100 provides information and communication between ECCs and infrastructure operations centers to handle emergency situations protecting the emergency responders and the public by providing the emergency responders with critical information, such as but not limited to hazardous material information, so that the proper handling procedures can be put into operation as quickly as possible, without unnecessary confusion or delays, to save the lives and health of the public while also protecting the emergency responders from the associated risks.

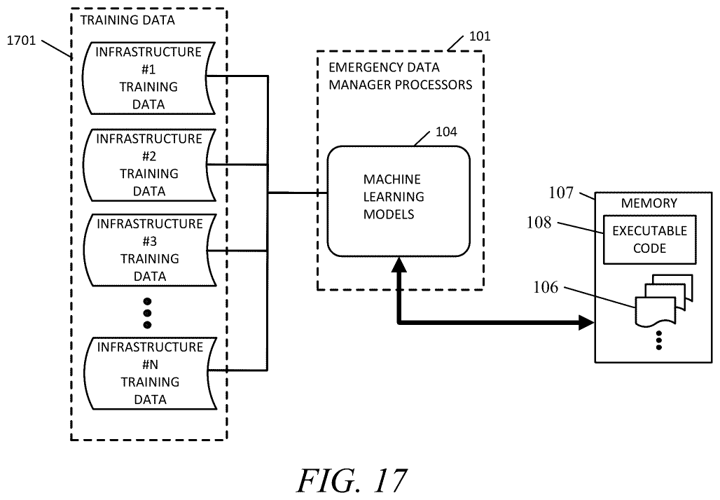

FIG. 17 is a diagram showing training of various infrastructure related machine learning prediction models in accordance with various embodiments. Training data 1701 from various infrastructure systems of various infrastructure types is used to train various machine learning models 104. In one example related to a railway infrastructure system, a regression model may be built using a neural network that may be trained to make predictions of train derailment emergencies or other emergencies using sensor data 133, or using a combination of sensor data 133 and emergency data from the emergency data manager 100, gathered over a specific period of time such as weeks, months or years. The machine learning models 104 may also be updated from time-to-time using new or additional training data, or may be updated using reinforcement learning from human feedback (RLHF) in order to optimize the machine learning models 104.

In some embodiments, the emergency data manager processors 101 may include one or more GPU servers that are designed specifically to accommodate training and utilization of AI (artificial intelligence) deep learning models such as machine learning models 104. The one or more GPU servers may, in some embodiments, be installed at an infrastructure operations center location or may be installed at an ECC location or a combination of both. In some embodiments, the GPU servers maybe cloud-based and form part of the emergency data manager 100 cloud-infrastructure or may be ancillary cloud-based servers operatively coupled to the emergency data manager 100 cloud infrastructure.

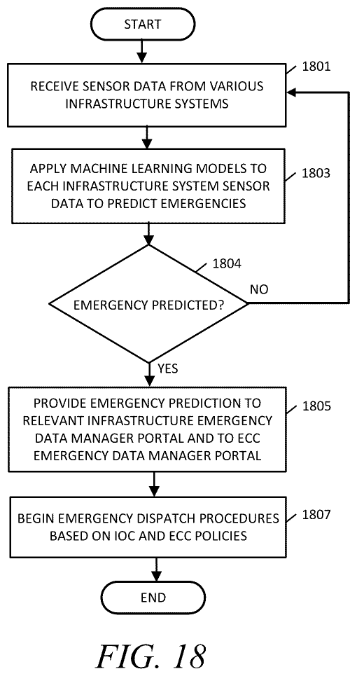

FIG. 18 is a flowchart showing a method of operation of an emergency data manager in accordance with various embodiments. In operation 1801, the emergency data manager 100 receives sensor data 133 from the infrastructure sensors 131 and provides the sensor data 133 to one or more machine learning models 104. The machine learning models 104 have been trained for a specific type of infrastructure system and therefore are trained to recognize emergencies for the specific infrastructure system type and to make predictions of emergencies. In operation 1803, one or more machine learning models 104 analyze the sensor data 133 and generate predictions. If no emergency is predicted at decision 1804, then the emergency data manager 100 continues to receive sensor data 133 at operation 1801 and send the sensor data 133 to the machine learning models 104 at operation 1803. If an emergency is predicted in decision 1804, then at operation 1805 the emergency data manager 100 provides the emergency prediction to the relevant infrastructure emergency data manager portal of an infrastructure operations center network entity, and also sends the emergency prediction to the relevant ECC emergency data manager portal. At operation 1807, emergency responder dispatch procedures may be invoked based on IOC and ECC policies.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. An emergency management system comprising:
a cloud server, comprising a network component and at least one processor, operatively coupled to the network component, the at least one processor, operative to:
provide a first data interface from the cloud server to an infrastructure operations center, the first data interface operative to receive infrastructure emergency data from the infrastructure operations center by the cloud server;
provide a second data interface from the cloud server to an information database, the second data interface operative to send a query from the cloud server to the information database comprising the infrastructure emergency data, and to receive infrastructure emergency handling protocol information by the cloud server in response to the query;
provide a third data interface from the cloud server to an emergency communications center network entity, operative to send an infrastructure emergency message to an emergency communication center to initiate dispatch of emergency responders to a location of the infrastructure emergency; and
send a message with infrastructure emergency information received via the second data interface to a plurality of emergency responder devices.

2. The emergency management system of claim 1, wherein the operation of send a message with infrastructure emergency information received via the second data interface to a plurality of emergency responder devices comprises:
sending the message comprising infrastructure emergency handling protocol information received via the second data interface, to a plurality of emergency responder devices.

3. The emergency management system of claim 1, wherein the operation of send a message with infrastructure emergency information received via the second data interface to a plurality of emergency responder devices comprises:
displaying a data card on the plurality of emergency responder devices.

4. The emergency management system of claim 1, wherein the operation of send a message with infrastructure emergency information received via the second data interface to a plurality of emergency responder devices comprises:
sending the message to a plurality of emergency responder devices at a substantially same time as sending the infrastructure emergency message to the emergency communication center to initiate dispatch of emergency responders to a location of the infrastructure emergency.

5. The emergency management system of claim 1, wherein the operation of wherein the operation of send a message with infrastructure emergency information received via the second data interface to a plurality of emergency responder devices comprises:
sending a webhook to the plurality of emergency responder devices.

6. The emergency management system of claim 5, further comprising:
sending the webhook as a preauthorized webhook with a uniform resource locator selectable to provide the infrastructure emergency handling protocol information.

7. The emergency management system of claim 1, wherein the operation of provide a third data interface from the cloud server to an emergency communications center network entity, operative to send an infrastructure emergency message to an emergency communication center to initiate dispatch of emergency responders to a location of the infrastructure emergency, comprises:
sending the infrastructure emergency message comprising a location and information related to the infrastructure emergency.

8. The emergency management system of claim 1, wherein the operation of wherein the operation of send a message with infrastructure emergency information received via the second data interface to a plurality of emergency responder devices comprises:
sending a short-message-service (SMS) message to the plurality of emergency responder devices.

9. The emergency management system of claim 8, further comprising:
sending the SMS message to the plurality of emergency responder devices comprising a uniform resource locator.

10. The emergency management system of claim 9, further comprising:
sending the uniform resource locator as a pre-authorized uniform resource locator.

11. A cloud server computer system comprising executable instructions for execution by the cloud server computer system, that when executed cause the cloud server computer system to be operative to:
obtain infrastructure condition information from a plurality of infrastructure operations center network entities, the infrastructure condition information associated with each of the plurality of infrastructure operations center network entities;
send infrastructure emergency information related to a plurality of infrastructure conditions, to a plurality of emergency communication center network entities to request dispatch of emergency responders to an infrastructure emergency; and
transmit infrastructure emergency information to a plurality of emergency responder devices in response to receiving infrastructure conditions.

12. The cloud server computer system of claim 11, wherein the cloud server computer system is further operative to:
transmit infrastructure emergency handling protocol information to the plurality of emergency responder devices in response to receiving infrastructure conditions.

13. The cloud server computer system of claim 11, wherein the cloud server computer system is further operative to:
provide an instance of an emergency data management application to at least one of the emergency communications center network entities via a first web browser executed on the at least one emergency communications center network entity, comprising a first graphical user interface (GUI) for display on the at least one emergency communications center network entity; and
provide an instance of an infrastructure emergency data management application to at least one of the infrastructure operations center network entities via a second web browser executed on the at least one infrastructure operations center network entity, comprising a second graphical user interface (GUI) for display on the at least one infrastructure operations center network entity.

14. The cloud server computer system of claim 11, wherein the cloud server computer system is further operative to:
receive infrastructure condition information related to an infrastructure emergency;
send an emergency an infrastructure emergency message comprising the infrastructure condition information to a specific emergency communications center in response to receiving the infrastructure condition information, to request dispatch of emergency responders; and
transmit infrastructure emergency handling protocol information to a group of emergency responder devices associated with the specific emergency communications center.

15. The cloud server computer system of claim 11, wherein the cloud server computer system is further operative to:
transmit infrastructure emergency handling protocol information comprising hazardous material handling protocol information.

16. The cloud server computer system of claim 13, wherein the cloud server computer system is further operative to:
provide the first GUI and the second GUI each comprising an emergency alert queue.

17. The cloud server computer system of claim 16, wherein the cloud server computer system is further operative to:
provide the first GUI and the second GUI each comprising a map view along with the emergency alert queue, the map view comprising at least one location indicator corresponding to a location of an infrastructure emergency.

18. The cloud server computer system of claim 13, wherein the cloud server computer system is further operative to:
provide the first GUI and the second GUI each comprising an emergency alert queue comprising icons for representation of a train derailment, and a train blocked crossing.

19. The cloud server computer system of claim 13, wherein the cloud server computer system is further operative to:
provide the first GUI and the second GUI each comprising an emergency alert queue comprising icons for representation of a hazardous material incident.

20. The cloud server computer system of claim 13, wherein the cloud server computer system is further operative to:
determine an event type for each emergency alert queue entry as an event type selected from the group of: a fire emergency event, a police emergency event, a medical emergency event, a train derailment, a train blocked crossing, a hazardous material incident; and
push the event type to the first GUI and to the second GUI.
